(19) United States
(12) Patent Application Publication
(10) Pub. No.: US 2019/0033590 A1
(43) Pub. Date: Jan. 31, 2019

(54) HEAD-UP DISPLAY DEVICE

(71) Applicant: NIPPON SEIKI CO., LTD., Niigata (JP)

(72) Inventors: Tsuyoshi KASAHARA, Niigata (JP); Yuichi TAKAHASHI, Niigata (JP)

(21) Appl. No.: 16/072,106

(22) PCT Filed: Jan. 16, 2017
(86) PCT No.: PCT/JP2017/001171

§ 371 Date: Jul. 23, 2018

(30) Foreign Application Priority Data
Jan. 27, 2016 (JP) 2016-013617

(51) Int. Cl. G02B 27/01; B60K 35/00; G09G 5/38

(52) U.S. Cl. CPC G02B 27/0149; B60K 35/00; G09G 5/38; G02B 27/0101; G02B 2027/0159; B60K 2350/2052; G09G 2380/10; G09G 2340/0464; B60K 2350/352

(57) ABSTRACT

The purpose of the present invention is to provide a head-up display device which reduces variations in the display position of a virtual image. This head-up display device is provided with: a projector that emits display light L representing an image; an optical system that displays a virtual image by projecting the display light L from the projector toward a windshield; and a optical path setting unit that sets the position of the virtual image when the head-up display device is activated to a preset regular position by adjusting the light path of the display light L through the optical system.

### TECHNICAL FIELD

The present invention relates to a head-up display device.

### BACKGROUND ART

There has been known a head-up display device, which allows a viewer to visually recognize a virtual image superimposed on a real view by irradiating display light on a projection member such as a windshield (see, for example, Patent Literature 1).

### CITATION LIST

### Patent Literature

Patent Literature 1: Japanese Unexamined Patent Application Publication No. 2004-126226

### SUMMARY OF THE INVENTION

### Problems to be Solved by the Invention

In the head-up display device, a shape error or an assembling error may occur on a windshield as an example of a projection member. These errors may cause variations in a position of a virtual image seen from a viewer for each head-up display device.

The present invention has been made in view of the above circumstances, and an object thereof is to provide a head-up display device that reduces variations in a display position of a virtual image.

### Solution to Problem

In order to achieve the above object, a head-up display device according to the present invention includes a display unit for irradiating display light representing an image, an optical system for displaying a virtual image by projecting the display light from the display unit toward a projection member, and an optical path setting unit for setting a position of the virtual image when the head-up display device is activated to a predetermined regular position by adjusting an optical path of the display light through the optical system.

### Effect of the Invention

According to the present invention, it is possible to reduce variations in a display position of a virtual image.

### BRIEF DESCRIPTION OF THE DRAWINGS

FIG. 1 is a schematic view of a vehicle on which a head-up display device according to a first embodiment is mounted.

FIG. 2 is a schematic diagram showing a configuration of a head-up display device according to a first embodiment.

FIG. 3 is a schematic view of a vehicle on which a head-up display device is mounted upon inspection by an inspection device according to a first embodiment.

FIG. 4 is a flowchart showing processing steps of a control unit when adjusting a position of a virtual image according to a first embodiment.

FIG. 5 is a schematic diagram showing an optical path and a virtual image in a head-up display device in accordance with a radius of curvature of a windshield according to a first embodiment.

FIG. 6 is a schematic diagram showing an optical path and a virtual image in a head-up display device when a first reflector according to a first embodiment is moved.

FIG. 7 is a schematic diagram showing an optical path and a virtual image in a head-up display device in accordance with a mounting angle of a windshield according to a first embodiment.

FIG. 8 is a schematic diagram showing an optical path and a virtual image in a head-up display device when first and second reflectors according to a first embodiment are tilted.

FIG. 9 is a schematic diagram showing a configuration of a head-up display device according to a second embodiment.

FIG. 10 is a schematic diagram showing an optical path and a virtual image in a head-up display device in accordance with a radius of curvature of a windshield according to a second embodiment.

FIG. 11 is a schematic diagram showing an optical path and a virtual image in a head-up display device in accordance with a mounting angle of a windshield according to a second embodiment.

FIG. 12 is a schematic diagram showing an optical path and a virtual image in a head-up display device when first and second reflectors according to a second embodiment are tilted.

### MODE FOR CARRYING OUT THE INVENTION

### First Embodiment

A head-up display device according to a first embodiment of the present invention will be described with reference to the drawings.

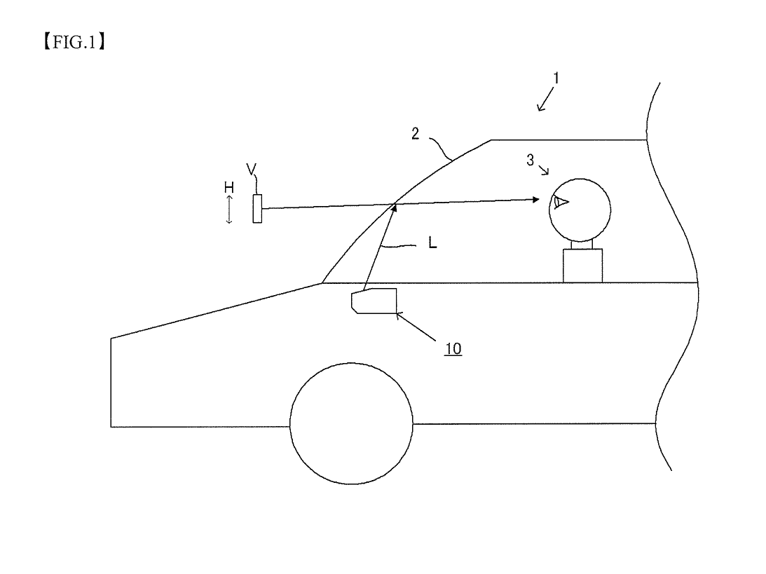

A head-up display device 10, as shown in FIG. 1, is mounted in a dashboard of a vehicle 1, and irradiates display light L on a windshield 2 of the vehicle 1. A viewer (passenger) 3 receives the display light L reflected on the windshield 2 and can visually recognize a virtual image V superimposed on a real view seen through the windshield 2.

(Configuration of Head-Up Display Device 10)

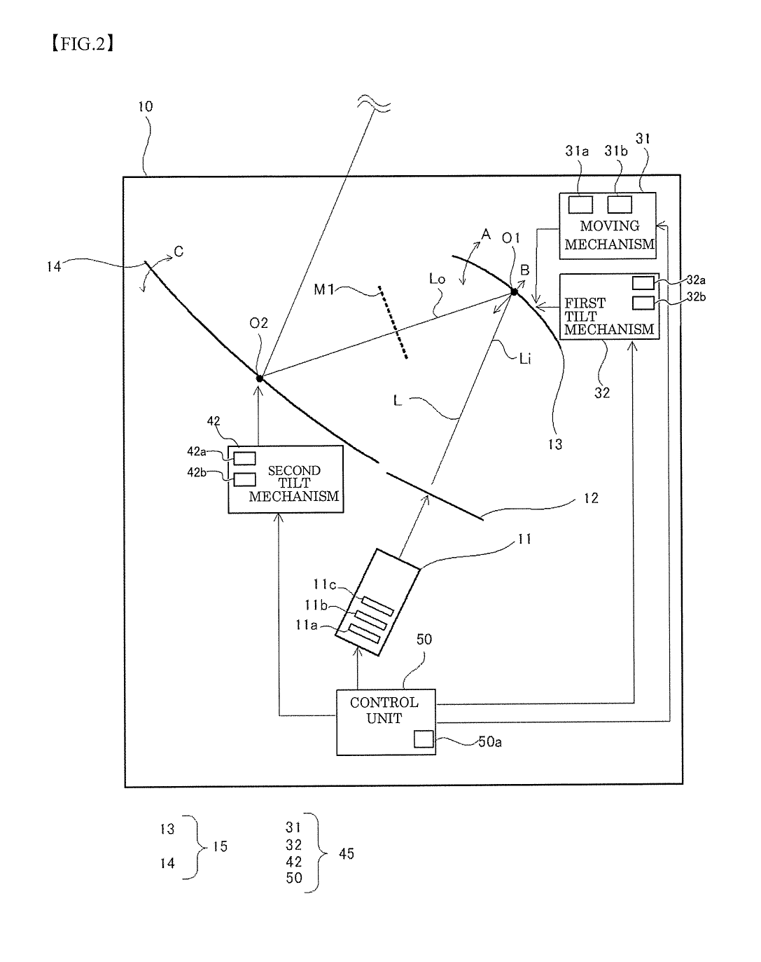

The head-up display device 10, as shown in FIG. 2, includes a projector 11 as an example of a display unit, a screen 12, an optical system 15, and an optical path setting unit 45. In this example, the optical system 15 includes first and second reflectors 13 and 14. Further, in this example, the optical path setting unit 45 includes a moving mechanism 31, first and second tilt mechanisms 32 and 42, and a control unit 50.

The projector 11, under the control of the control unit 50, irradiates display light L representing an image. Specifically, the projector 11 includes a light source 11a such as an LED (Light Emitting Diode), a display element 11b such as a liquid crystal panel that generates display light L representing an image based on light from the light source 11a, and an optical component 11c such as a lens for magnifying the display light L passing through the display element 11b.

The screen 12 is, for example, a rectangular plate-like polycarbonate diffusion film. The screen 12 receives the display light L from the projector 11 on one side facing the projector 11, and transmits and diffuses the display light L toward the other side facing the first reflector 13 and forms an image on the other surface side.

The first reflector 13 is a concave mirror, and has, for example, a rectangular plate shape curved in a transverse direction. The first reflector 13 includes a substrate made of, for example, a polycarbonate resin and a reflecting material such as aluminum deposited on the substrate. The first reflector 13 reflects the display light L from the screen 12 toward the second reflector 14, and forms an intermediate image M1 as a real image between the first and second reflectors 13 and 14.

The first tilt mechanism 32 is configured to be capable of tilting the first reflector 13 in a tilt direction A about its rotation axis O1 under the control of the control unit 50. The rotation axis O1 is located at the center in the transverse direction of the first reflector 13, and extends in the longitudinal direction of the first reflector 13 (direction perpendicular to the paper surface of FIG. 2). The first tilt mechanism 32 includes a motor 32a and a transmission mechanism 32b for transmitting rotational motion by the motor 32a to the first reflector 13.

The moving mechanism 31 is configured to linearly move the first reflector 13 in a linear direction B orthogonal to the rotation axis O1 and along a thickness direction of the first reflector 13 under the control of the control unit 50. In other words, the linear direction B extends along a centerline extending between incident light Li of the display light L incident on the first reflector 13 and reflected light Lo of the display light L reflected by the first reflector 13.

The moving mechanism 31 includes, for example, a motor 31a, and a transmission mechanism 31b for converting rotational motion by the motor 31a into linear motion and transmitting the linear motion to the first reflector 13. The transmission mechanism 31b is constituted by, for example, a rack & pinion mechanism.

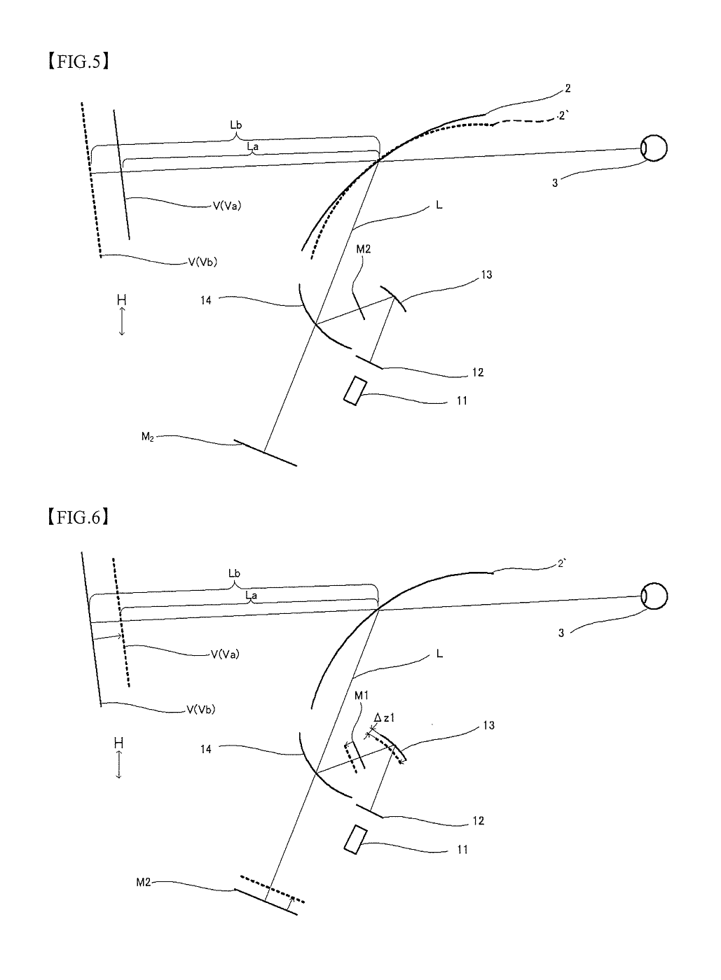

The second reflector 14 is a concave mirror having the same configuration as that of the first reflector 13, and has, for example, a rectangular plate shape curved in a transverse direction. A reflecting surface of the second reflector 14 has an area larger than a reflecting surface of the first reflector 13. The second reflector 14 enlarges while reflecting the intermediate image M1 formed by the display light L. At this time, as shown in FIG. 5, the second reflector 14 forms an intermediate image M2 that is a virtual image obtained by enlarging the intermediate image M1.

As shown in FIG. 2, the second tilt mechanism 42 is configured to be capable of tilting the second reflector 14 in a tilt direction C about its rotation axis O2 under the control of the control unit 50. The rotation axis O2 is located at the center in a transverse direction of the second reflector 14 and extends in a longitudinal direction of the second reflector 14 (the direction perpendicular to the paper surface of FIG. 2). The second tilt mechanism 42 includes a motor 42a and a transmission mechanism 42b for transmitting rotational motion by the motor 42a to the second reflector 14.

The control unit 50 is constituted by, for example, a microcomputer, and controls the projector 11, the moving mechanism 31, the first and second tilt mechanisms 32,42 based on information from a not-shown in-vehicle ECU (Electronic Control Unit). Further, the control unit 50 includes a nonvolatile memory 50a. The memory 50a stores proper virtual image position (regular position) information concerning a position of a normal virtual image Va.

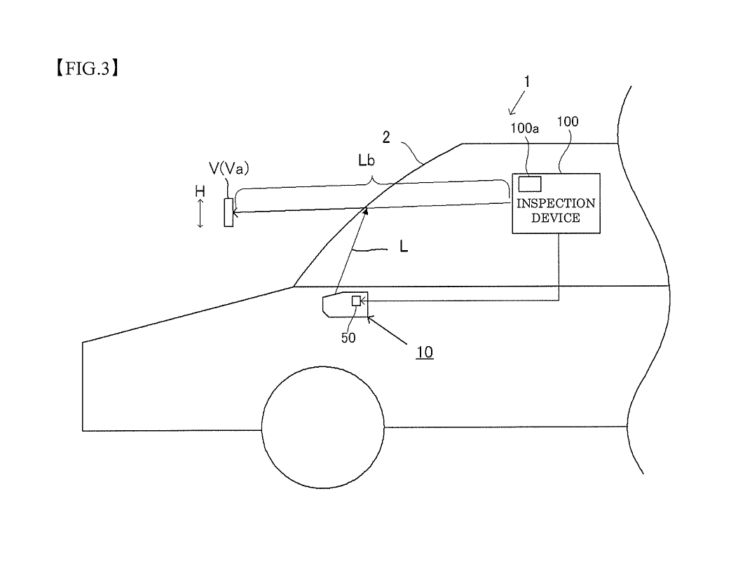

As shown in FIG. 3, in a manufacturing stage, after mounting the head-up display device 10 on the vehicle 1, the position of the virtual image V is inspected using an inspection device 100. Specifically, the inspection device 100 includes a stereo camera 100a for photographing the virtual image V, and measures the position of the virtual image V based on the photography result by the stereo camera 100a. The inspection device 100 outputs the measurement result to the control unit 50 of the head-up display device 10 connected to the inspection device 100. The measurement result includes a distance Lb from the windshield 2 to the virtual image V and a height H of the virtual image V.

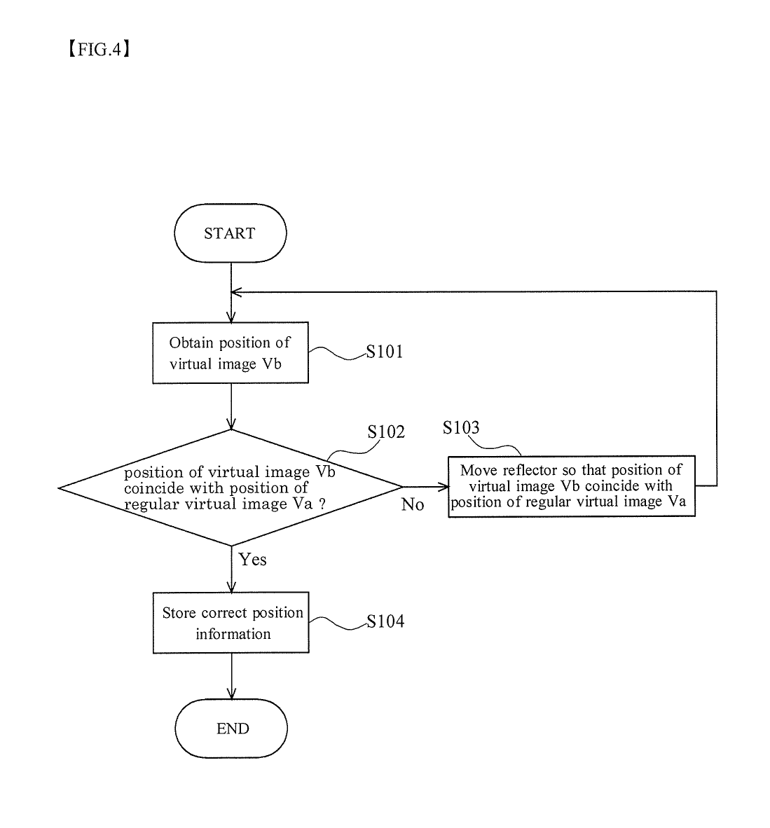

(Flowchart Executed by Control Unit 50) Next, referring to the flowchart of FIG. 4, processing steps of the control unit 50 when adjusting the position of the virtual image V will be described. This flow chart is executed in the manufacturing stage of the vehicle 1, more specifically, after the vehicle 1 is assembled.

First, the control unit 50 obtains the position of the virtual image Vb (see FIG. 5, for example) based on the measurement result from the inspection device 100 (S101). Next, the control unit 50 determines whether or not the position of the virtual image Vb before adjustment coincides with the position of the normal virtual image Va stored in the memory 50a (S102). When the control unit 50 determines that the position of the virtual image Vb before adjustment is different from the position of the normal virtual image Va (No in S102), the control unit 50 moves the first and second reflectors 13 and 14 via the moving mechanism 31 and the first and second 2 tilt mechanisms 32, 42 so that the virtual image Vb coincides with the normal virtual image Va (S103). At this time, the control unit 50 calculates the amount of movement of the first and second reflectors 13, 14, which are necessary to adjust the virtual image Vb to the normal virtual image Va, and moves the first and second reflectors 13 and 14 based on the calculation result. A specific relationship between the moving modes of the first and second reflectors 13, 14 and the moving manner of the virtual image V will be described later.

Then, the control unit 50 returns again to step S101. That is, the control unit 50 repeatedly performs the processing of steps S101 to S103 until the position of the virtual image Vb based on the measurement result of the inspection device 100 coincides with the position of the normal virtual image Va. When the control unit 50 determines that the position of the virtual image Vb based on the measurement result of the inspection device 100 coincides with the position of the regular virtual image Va (Yes in S102), the control unit 50 stores the positions and angles of the first and second reflectors 13 and 14 at that time in the memory 50a as correct position information (S104), and terminates the process related to the flowchart.

Further, for example, when the power supply of the head-up display device 10 is turned off, the control unit 50 sets the positions and angles of the first and second reflectors 13, 14 to protected positions to deviate backward external light from the projector 11 so that the backward external light is suppressed from irradiating on the projector 11.

Then, for example, when the head-up display device 10 is activated (turned on), the control unit 50 moves the positions and angles of the first and second reflectors 13 and 14 from the protected positions in accordance with the correct position information stored in the memory 50a.

(Operations of First and Second Reflectors 13, 14)

Next, a detailed description will be given on a position change of the virtual image V when the first and second reflectors 13 and 14 are operated through the moving mechanism 31 and the first and second tilt mechanisms 32 and 42 in step S103 of the flowchart described above.

As shown in FIG. 5, the curvature radii of the windshields 2, 2′ may vary for each vehicle 1 due to a shape tolerance. For example, in the example of FIG. 5, the windshield 2 indicated by a solid line has a normal radius of curvature, and the windshield 2′ indicated by a broken line has a smaller radius of curvature than the windshield 2. The position of the virtual image V becomes farther from the viewer 3 as the radii of curvature of the windshields 2, 2′ decrease. Therefore, the virtual image Vb corresponding to the windshield 2′ is farther away from the viewer 3 than the virtual image Va corresponding to the windshield 2.

For example, when the windshield 2′ having a small curvature radius is mounted on the vehicle 1, the control unit 50 recognizes the distance Lb from the windshield 2′ to the virtual image Vb based on the measurement result from the inspection device 100. Then, the control unit 50 calculates a moving amount Δz1 of the first reflector 13 that is necessary for adjusting the recognized distance Lb to the distance La from the windshield 2 to the normal virtual image Va stored as proper virtual image position information stored in the memory 50a. As shown in FIGS. 2 and 6, the control unit 50 moves the first reflector 13 linearly by the calculated moving amount Δz1 via the moving mechanism 31. As a result, the positions of two intermediate images M1, M2, furthermore, the position of the virtual image V moves, and the distance Lb from the windshield 2′ to the virtual image V changes to approach the distance La.

More specifically, as indicated by the arrow in FIG. 6, the control unit 50 moves the first reflector 13 in a direction approaching the second reflector 14 or the screen 12 by the calculated moving amount Δz1, thereby moving the two intermediate images M1 and M2 in a direction approaching the second reflector 14, and as a result, moving the virtual image Vb in a direction approaching the windshield 2′. On the contrary, when the control unit moves the first reflector 13 in a direction away from the second reflector 14 or the screen 12, the two intermediate images M1 and M 2 move in a direction away from the second reflector 14, and as a result, the virtual image V moves in a direction away from the windshield 2′.

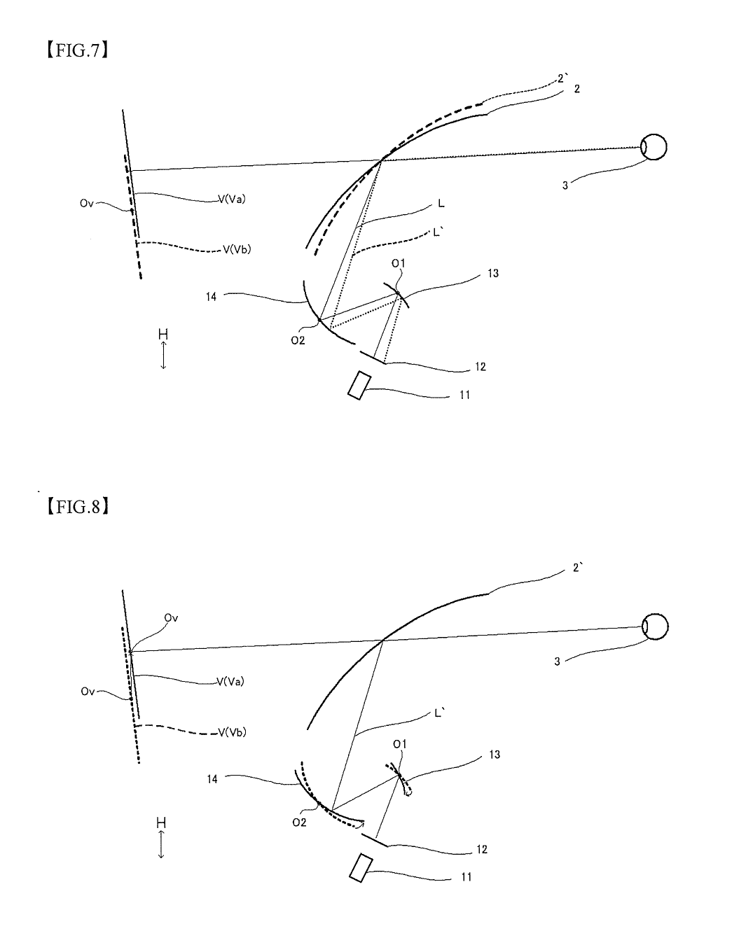

Further, as shown in FIG. 7, the mounting angles of the windshields 2, 2′ may vary for each vehicle 1. In the example of FIG. 7, the windshield 2 is mounted at a normal angle, and the windshield 2′ is mounted so that its concave surface faces the viewer 3 as compared with the windshield 2, in other words, at a position rotated counterclockwise from the windshield 2 in FIG. 7.

The virtual image V moves downward as the windshield 2′ rotates counterclockwise in FIG. 7. When the windshield 2′ is mounted on the vehicle 1, when the optical path of the display light L is traced with respect to the center point Ov, the display light L′ shown by a broken line in FIG. 7 is deviated from the rotation axis O1 of the first reflector 13 and the rotation axis O2 of the second reflector 14.

As shown in FIG. 8, the control unit 50 tilts the first and second reflectors 13, 14 via the first and second tilt mechanisms 32, 42 to adjust the display light L′ corresponding to the center point Ov of the virtual image Vb to the rotation axis O1 of the first reflector 13. As a result, the virtual image Vb moves until it reaches the same height H as the normal virtual image Va.

(Effect)

According to the first embodiment described above, the following effects are particularly obtained.

(1) The head-up display device 10 includes a projector 11 for irradiating display light L representing an image, an optical system 15 for displaying a virtual image V by projecting display the light L passing through a screen 12 from a projector 11 toward a windshield 2, and an optical path setting unit 45 for setting a position of the virtual image V when the head-up display device 10 is activated to a regular position stored in advance in a memory 50a by adjusting an optical path of the display light L through the optical system 15.

With this configuration, the optical path setting unit 45 can reduce variations in the display position of the virtual image V for each head-up display device 10.

(2) The optical system 15 includes a first reflector 13 for reflecting the display light L from the projector 11, and a second reflector 14 for reflecting the display light L reflected by the first reflector 13 toward the windshield 2. The optical path setting unit 45 includes a moving mechanism 31, which changes a distance from the windshield 2 to the virtual image V by moving the first reflector 13 along a centerline extending between incident light Li of the display light L incident on the first reflector 13 and the reflected light Lo of the display light L reflected by the first reflector 13.

With this configuration, it is possible to easily change the distance from the windshield 2 to the virtual image V by merely moving the first reflector 13 linearly by the moving mechanism 31.

(3) The optical path setting unit 45 includes tilt mechanisms 32, 42 for tilting the first and second reflectors 13, 14 to move the virtual image V in a height H direction.

With this configuration, the tilt mechanisms 32, 42 can reduce variations in the height of the virtual image V for each head-up display device 10.

(4) The optical path setting unit 45 includes a memory 50a for storing correct position information, which is positional information of the first and second reflectors 13 and 14 for the virtual image V to be in a regular position, and a control unit 50, which sets the positions and angles of the first and second reflectors 13, 14 to protected positions for protecting the projector 11 from external light when the power supply of the head-up display device 10 is turned off, and moves the positions and angles of the first and second reflectors 13, 14 from the protected positions in accordance with the correct position information stored in the memory 50a when the head-up display device 10 is turned on.

With this configuration, when the head-up display device 10 is powered off, the first and second reflectors 13, 14 are in the protected positions, and the external light is suppressed from irradiating on the projector 11. Further, when the head-up display device 10 is turned on, the first and second reflectors 13 and 14 are moved in accordance with the correct position information, and the virtual image V can be set to a regular position.

### Second Embodiment

A head-up display device according to a second embodiment of the present invention will be described with reference to the drawings. In this embodiment, differences from the first embodiment will be mainly described.

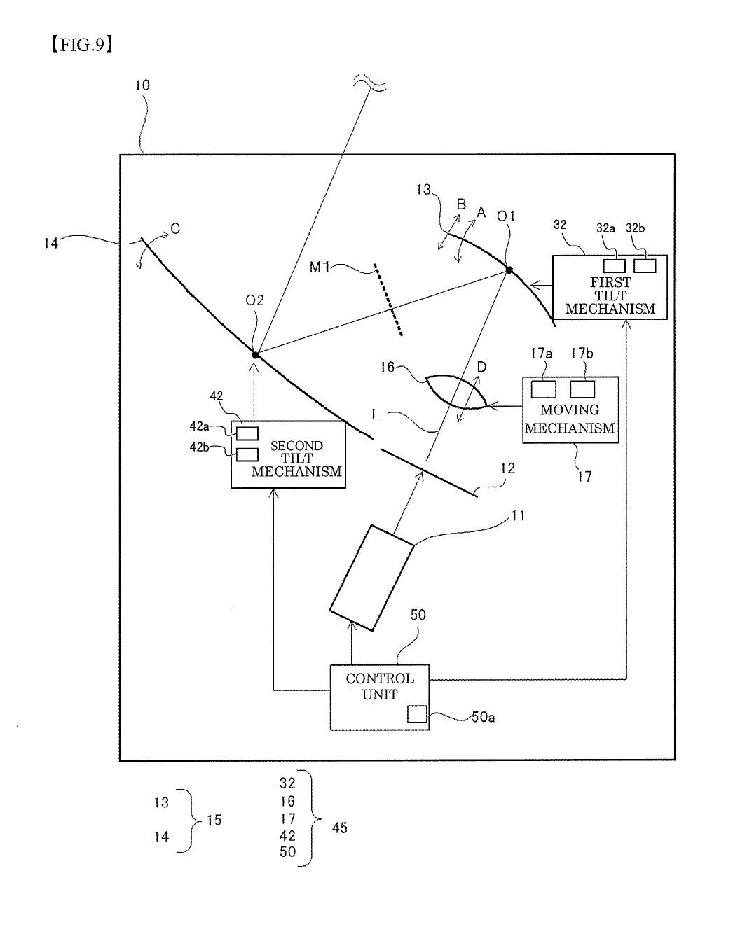

As can be understood by comparing FIG. 9 according to this embodiment with FIG. 2 according to the first embodiment, in this embodiment, the moving mechanism 31 for linearly moving the first reflector 13 is omitted, and a correction lens 16 and a corresponding moving mechanism 17 are provided. The correction lens 16 and the moving mechanism 17 constitute the optical path setting unit 45.

As shown in FIG. 9, the correction lens 16 is, for example, a biconvex lens made of a polycarbonate resin. The correction lens 16 has a rectangular shape like the screen 12 when viewed from the thickness direction. The correction lens 16 receives the display light L from the screen 12 and forms the display light L on the first reflector 13 side.

The moving mechanism 17 is configured to linearly move the correction lens 16 in a direction D along the optical axis of the display light L under the control of the control unit 50. The moving mechanism 17 includes, for example, a motor 17a and a transmission mechanism 17b for converting rotational motion by the motor 17a into linear motion and transmitting the linear motion to the correction lens 16. The transmission mechanism 17b is constituted by, for example, a rack & pinion mechanism.

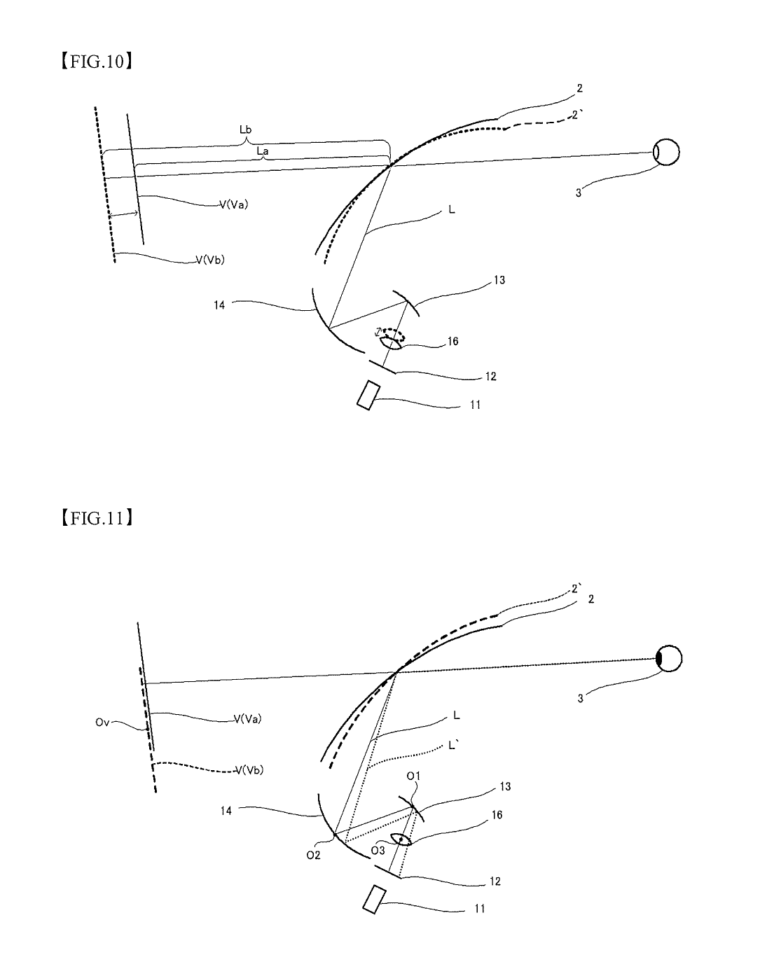

As shown in FIG. 10, the virtual image V moves away from the windshield 2 when the correction lens 16 is moved away from the projector 11 by the moving mechanism 17, and the virtual image V moves close to the windshield 2 when the correction lens 16 is moved close to the projector 11.

As shown in FIG. 10, as described in the first embodiment, when the radius of curvature of the windshield 2′ is small, the distance Lb from the windshield 2′ to the virtual image V b increases. In this case, the control unit 50 moves the correction lens 16 via the moving mechanism 17 instead of step S103 in the flowchart of FIG. 4, so that the position of the virtual image Vb coincides with the position of the normal virtual image Va stored in the memory 50a.

When the height of the virtual image Vb deviates from the normal virtual image Va due to variations in the mounting angle of the windshield 2′, as shown in FIG. 11, when the optical path of the display light L is traced with reference to the center point Ov of the virtual image Vb, the display light L′ indicated by a broken line in FIG. 11 deviates from the rotation axis O1 of the first reflector 13 and the rotating axis O2 of the second reflector 14, and is further deviated from the center O3 of the correction lens 16.

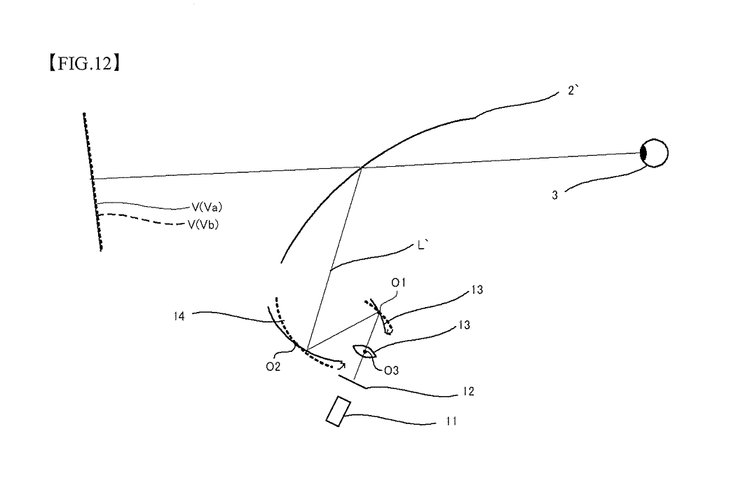

In this case, as shown in FIG. 12, the control unit 50 tilts the first and second reflectors 13, 14 through the first and second tilt mechanisms 32, 42, thereby adjusting the display light L′ to the rotation axis O1 of the first reflector 13 and the center O3 of the correction lens 16. As a result, the height of the virtual image Vb becomes the same as the normal virtual image Va. In the example of FIG. 12, the second reflector 14 is rotated counterclockwise by a predetermined angle in FIG. 12, and the first reflector 13 is rotated clockwise by a predetermined angle in FIG. 12.

(Effect)

According to the second embodiment described above, the following effects are particularly obtained.

(1) The optical path setting unit 45 includes a correction lens 16 positioned between the projector 11 and the first reflector 13 for receiving the display light L passing through the screen 12 from the projector 11 and forming the display light L on the first reflector 13 side, and a moving mechanism 17 for changing a distance from the windshield 2 to the virtual image V by moving the correction lens 16 along the traveling direction of the display light L passing through the correction lens 16.

With this configuration, the position of the virtual image V from the windshield 2 can be changed only by linearly moving the correction lens 16 by the moving mechanism 17. This makes it possible to reduce variations in the display position of the virtual image V for each head-up display device 10. Further, the display position of the virtual image V can be changed by the moving mechanism 17 and the correction lens 16 without moving the first and second reflectors 13, 14.

### Modified Example

The above embodiments are implemented in the following modes appropriately modified.

In the first embodiment, the control unit 50 adjusts the position of the virtual image V by moving the first and second reflectors 13, 14. However, distortion of the virtual image V may be corrected by moving the first and second reflectors 13, 14 instead of adjusting the position of the virtual image V. Also in the second embodiment, the control unit 50 may correct the distortion of the virtual image V by moving the first and second reflectors 13, 14 and the correction lens 16. For example, the control unit 50 distorts an image projected on the screen 12 in advance by image processing called warping in order to correct distortion of a virtual image caused by a shape tolerance of a windshield. The distortion of the virtual image V can be checked by the inspection device 100.

In each of the above embodiments, the flowchart of FIG. 4 is executed in the manufacturing stage of the vehicle 1. However the embodiment is not limited to this, and the flowchart may be executed during use of the vehicle 1. In this case, the inspection device 100 is mounted on the vehicle 1, and the control unit 50 recognizes the position of the virtual image V based on the imaging result of the inspection device 100 mounted on the vehicle 1.

In the first embodiment, only the first reflector 13 is configured to be linearly movable by the moving mechanism 31, but the second reflector 14 may also be configured to be linearly movable by newly providing a moving mechanism corresponding to the second reflector 14.

In the first embodiment, the moving mechanism 31 includes the motor 31a, but any actuator may be used as long as linearly moving the first reflector 13. For example, a solenoid may be provided instead of the motor 31a.

In each of the above embodiments, an input operation unit (not shown) operated by the viewer 3 may be mounted on the vehicle 1, and by operating the input operation unit, the positions and angles of the first and second reflectors 13,14 or the backlight brightness may be made adjustable.

In the first embodiment, as shown in the flowchart of FIG. 4, the control unit 50 returns to the processing of step S101 after moving the first and second reflectors 13, 14 (S103) so that the virtual image Vb based on the measurement result from the inspection device 100 coincides with the normal virtual image Va, but the control unit 50 may terminate the process related to the flowchart of FIG. 4 without returning to the processing of step S101.

In the first embodiment, when Yes in step S102, the control unit 50 stores the positions and angles of the first and second reflectors 13, 14 at that time as correct position information in the memory 50a. However, for example, when Yes in step S102, the control unit may fix the first and second reflectors 13, 14 at the positions and angles of the first and second reflectors 13, 14 at that time without storing the correct position information. In this case, the controller 50 does not move the positions and angles of the first and second reflectors 13, 14 to the protected positions when the power supply of the head-up display device 10 is turned off.

In the above embodiment, the head-up display device 10 projects the display light L onto the windshield 2. However, the embodiment is not limited to this, and the display light L may be projected onto a combiner consisting of a plate-like half mirror, a hologram element and the like. In this configuration, if the configuration of the above embodiment is applied, it is possible to reduce variations in the display position of the virtual image V caused by a shape error of the combiner and the like.

In each of the above embodiments, the projector 11 is used as a display unit. However, as a display unit, a unit for displaying an image (real image) without a screen 12, for example, a display panel may be used.

### INDUSTRIAL APPLICABILITY

The present invention is applicable as a display device mounted on a vehicle or the like for displaying information to a driver.

### DESCRIPTION OF REFERENCE NUMERALS

2, 2′ Windshield
10 Head-up display device
11 Projector
11a Light source
11b Display element
11c Optical component
12 Screen
13 First reflector
14 Second reflector
15 Optical system
16 Correction lens
17 Moving mechanism
17a Motor
17b Transmission mechanism
31 Moving mechanism
31a Motor
31b Transmission mechanism
32 Tilt mechanism
32a Motor
32b Transmission mechanism
42 Tilt mechanism
42a Motor
42b Transmission mechanism
45 Optical path setting unit
50 Control unit
50a Memory
100 Inspection device
100a Stereo camera

1. A head-up display device comprising:
a display unit for irradiating display light representing an image;
an optical system for displaying a virtual image by projecting the display light from the display unit toward a projection member; and
the head-up display device including an optical path setting unit for setting a position of the virtual image when the head-up display is activated to a predetermined regular position by adjusting an optical path of the display light through the optical system.

2. The head-up display device according to claim 1, wherein:
the optical system includes
a first reflector for reflecting the display light from the display unit and
a second reflector for reflecting the display light reflected by the first reflector toward the projection member; and
the optical path setting unit includes a moving mechanism, which changes a distance from the projection member to the virtual image by moving the first reflector along a centerline extending between an incident light of the display light incident on the first reflector and a reflected light of the display light reflected by the first reflector.

3. The head-up display device according to claim 1, wherein:
the optical system includes
a first reflector for reflecting the display light from the display unit and
a second reflector for reflecting the display light reflected by the first reflector toward the projection member; and
the optical path setting unit includes
a correction lens positioned between the display unit and the first reflector for receiving the display light from the display unit and forming an image of the display light on the first reflector side and
a moving mechanism, which changes a distance from the projection member to the virtual image by moving the correction lens along a traveling direction of the display light passing through the correction lens.

4. The head-up display device according to claim 2, wherein
the optical path setting unit includes a tilt mechanism for tilting the first and second reflectors to move the virtual image in a height direction.

5. The head-up display device according to claim 1, wherein:
the optical path setting unit includes a memory for storing correct position information that is positional information of the optical system for the virtual image to be in a regular position; and
a control unit, which sets a position of the optical system to a protected position in which the display unit is protected from external light when power supply of the head-up display device is turned off, and moves a position of the optical system from the protected position in accordance with the correct position information stored in the memory when the head-up display device is activated.

6. The head-up display device according to claim 3, wherein
the optical path setting unit includes a tilt mechanism for tilting the first and second reflectors to move the virtual image in a height direction.

7. The head-up display device according to claim 2, wherein:
the optical path setting unit includes a memory for storing correct position information that is positional information of the optical system for the virtual image to be in a regular position; and
a control unit, which sets a position of the optical system to a protected position in which the display unit is protected from external light when power supply of the head-up display device is turned off, and moves a position of the optical system from the protected position in accordance with the correct position information stored in the memory when the head-up display device is activated.

8. The head-up display device according to claim 3, wherein:
the optical path setting unit includes a memory for storing correct position information that is positional information of the optical system for the virtual image to be in a regular position; and
a control unit, which sets a position of the optical system to a protected position in which the display unit is protected from external light when power supply of the head-up display device is turned off, and moves a position of the optical system from the protected position in accordance with the correct position information stored in the memory when the head-up display device is activated.

9. The head-up display device according to claim 4, wherein:
the optical path setting unit includes a memory for storing correct position information that is positional information of the optical system for the virtual image to be in a regular position; and
a control unit, which sets a position of the optical system to a protected position in which the display unit is protected from external light when power supply of the head-up display device is turned off, and moves a position of the optical system from the protected position in accordance with the correct position information stored in the memory when the head-up display device is activated.
